(19) United States
(12) Patent Application Publication
(10) Pub. No.: US 2005/0266232 A1
(43) Pub. Date: Dec. 1, 2005

(54) Weatherable multilayer articles and process for making

(75) Inventors: Hua Wang, Clifton Park, NY (US); Randall Todd Myers, Pittsfield, MA (US); Scott Michael Davis, Lee, MA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/857,478

(22) Filed: May 27, 2004

(51) Int. Cl. B32B 5/16

(52) U.S. Cl. 428/323

(57) ABSTRACT

The weatherability of a multilayer article comprising a top layer and a substrate layer is enhanced by the addition of a fiber in a thermoplastic polymer substrate. The top layer includes at least one thermoplastic polymer comprising structural units derived from at least one 1,3-dihydroxybenzene and at least one organodicarboxylic acid. Processes for making the aforementioned multilayer article are also provided in the present invention.

### BACKGROUND OF THE INVENTION

This invention relates to color stability, and more particularly to improvement of the color stability of compositions containing arylate-comprising polymers.

Coatings made from polyesters containing resorcinol arylate units often possess good weatherability properties. “Good weatherability properties” as used herein signify resistance to photoyellowing of the resinous article as well as loss of gloss. The arylate moieties typically contain isophthalate, terephthalate, and especially mixtures of iso- and terephthalate units. Polyesters of resorcinol with mixtures of isophthalate and terephthalate chain members typically have good weatherability properties and may provide protection against photoyellowing when coated over a resinous substrate.

The good weatherability properties of polyesters containing resorcinol arylate units are believed to arise in large part from the screening effect said polymers may provide to ultraviolet (UV) light. On exposure to UV light, polymers comprising resorcinol arylate chain members may undergo photochemical Fries rearrangement converting at least a portion of the polymer from polyester chain members to o-hydroxybenzophenone-type chain members. The o-hydroxybenzophenone-type chain members act to further screen UV light and protect UV-sensitive components in a resorcinol arylate-containing composition. The good weatherability properties of polymers comprising resorcinol arylate chain members make them especially useful in blends and in multilayer articles in which said polymers may act as a protecting layer for more sensitive substrate components.

Multilayer articles comprising a weatherable film such as a film of polyesters containing resorcinol arylate units as a top layer and an un-reinforced thermoplastic substrate via an in-mold-decoration (IMD) process have demonstrated outstanding properties suitable for applications in automotive vertical panels like fenders and doors, other outdoor vehicles and devices, protected graphics such as signs, outdoor enclosures such as telecommunication and electrical connection boxes, and construction applications such as roof sections, wall panels, and glazing. However, these parts do not offer the advantages of lightweight and dimension stability.

It remains of interest, therefore, to develop a method for preparing weatherable, lightweight multilayer articles which are capable of use for such varied purposes as body parts for outdoor vehicles and devices such as automobiles.

### BRIEF DESCRIPTION OF THE INVENTION

The present invention provides a multilayer article comprising:
a substrate layer comprising at least one thermoplastic polymer and fiber in a range between about 15 weight % and about 75 weight % based on the total weight of the fiber-reinforced polymer substrate, and at least one top layer comprising at least one thermoplastic polymer comprising structural units derived from at least one 1,3-dihydroxybenzene and at least one organodicarboxylic acid.

The present invention further provides a process for making a multilayer article comprising:
forming a substrate layer comprising at least one thermoplastic polymer and fiber in a range between about 15 weight % and about 75 weight % based on the total weight of the fiber-reinforced polymer substrate,
cooling the substrate layer,
placing a top layer comprising at least one thermoplastic polymer comprising structural units derived from at least one 1,3-dihydroxybenzene and at least one organodicarboxylic acid on the cooled substrate layer, and
molding the multilayer article by heating the substrate layer and top layer at a temperature less than the glass transition temperature of the thermoplastic polymer top layer and at a pressure in a range between about 15 psi and about 800 psi.

The present invention further provides a process for making a multilayer article comprising:
forming a top layer comprising at least one thermoplastic polymer comprising structural units derived from at least one 1,3-dihydroxybenzene and at least one organodicarboxylic acid,
heating a substrate layer comprising at least one thermoplastic polymer and fiber in a range between about 15 weight % and about 75 weight % based on the total weight of the fiber-reinforced polymer substrate to a temperature in a range between about 180° C. and about 370° C.,
placing the top layer and the heated substrate layer in a compression mold wherein the aesthetic side of the top layer is contiguous to the surface of the compression mold, and
molding the top layer and heated substrate layer at a temperature below the glass transition temperature of the thermoplastic polymer top layer and at a pressure in a range between about 10 psi and about 900 psi.

The present invention further a process for making a multilayer article comprising:
placing a top layer comprising at least one thermoplastic polymer comprising structural units derived from at least one 1,3-dihydroxybenzene and at least one organodicarboxylic acid in an injection molding tool wherein the aesthetic side of the top layer is contiguous to the surface of the tool,
placing a substrate layer comprising at least one thermoplastic polymer and fiber in a range between about 15 weight % and about 75 weight % based on the total weight of the fiber-reinforced polymer substrate in the injection molding tool,
injection molding a thermoplastic resin between the top layer and the substrate layer.

### DETAILED DESCRIPTION OF THE DRAWINGS

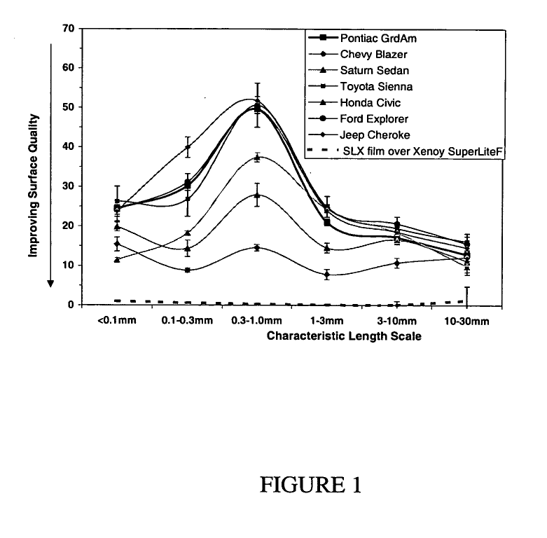

FIG. 1 is a graphical representation of wavescan measurements of painted automotive exteriors and molded Lexan® SLX film over a Xenoy Superlite substrate.

### DETAILED DESCRIPTION OF THE INVENTION

As used herein the term polymer comprises homopolymers, copolymers, interpolymers, higher order copolymers, and higher order interpolymers, but is not limited to these specific genera of polymeric materials.

The present invention comprises multilayer articles comprising at least two layers. In one embodiment, multilayer articles of the present invention are those comprising a substrate layer which includes a thermoplastic material that is reinforced with fibers and at least one top layer which includes a polymer with structural units derived from at least one 1,3-dihydroxybenzene and at least one organodicarboxylic acid.

The substrate of the present invention is a thermoplastic material that is reinforced with fibers to produce a substrate with a high stiffness to weight ratio. Here the stiffness to weight ratio is defined as the ratio of the tensile modulus (in psi) over the specific gravity of the material. “High stiffness to weight ratio” as used herein refers to a ratio in a range between about 100,000 pounds per square inch (psi) and about 1,000,000 psi. Any rigid fibers may be used which include, for example, glass fibers, carbon fibers, metal fibers, ceramic fibers, whiskers or combinations thereof. Preferred fibers will not add color when combined to the thermoplastic material. Preferred fibers of the invention will have modulus of greater than or equal to 1,000,000 psi. The fiber strands may be chopped or continuous. The fibers may have various cross-sections for example, round, crescent, bilobal, trilobal, rectangular and hexagonal. Preferably, the fibers of the present invention are glass and more preferably, the fibers are dispersed chopped glass fiber.

Preferred fibers will have a diameter in a range between about 5 microns and about 25 microns with a diameter in a range between about 6 microns and about 17 microns being most preferred. In some applications it may be desirable to treat the surface of the fiber with a chemical coupling agent to improve adhesion to the thermoplastic material. Examples of useful coupling agents are alkoxy silanes and alkoxy zirconates. Amino, epoxy, amide, or thio functional alkoxy silanes are especially useful.

The thermoplastic material of the substrate layer in the multilayer articles of this invention is at least one thermoplastic polymer, whether addition or condensation prepared. Condensation polymers include, but are not limited to, polycarbonates, particularly aromatic polycarbonates, polyphenylene ethers, polyetherimides, polyetherketones, polyetheretherketones, polyesters and polyestercarbonates (different from those that may be employed for the top layer, as defined hereinafter), and polyamides. Preferred condensation thermoplastic polymers are polyetherimides.

Suitable addition polymer substrates include homo- and copolymeric aliphatic olefin and functionalized olefin polymers such as polyethylene, polypropylene, poly(vinyl chloride), poly(vinyl chloride-co-vinylidene chloride), poly(vinyl fluoride), poly(vinylidene fluoride), poly(vinyl acetate), poly(vinyl alcohol), poly(vinyl butyral), poly(acrylonitrile), acrylic polymers such as those of (meth)acrylamides or of alkyl (meth)acrylates such as poly(methyl methacrylate) (“PMMA”), and polymers of alkenylaromatic compounds such as polystyrenes, including syndiotactic polystyrene. The preferred addition polymers for many purposes are polypropylenes.

Blends of any of the foregoing types and species of polymers may also be employed as substrates. Typical blends include, but are not limited to those comprising PC/ABS, PC/ASA, PC/PBT, PC/PET, PC/polyetherimide, PC/polysulfone, polyester/polyetherimide, PMMA/acrylic rubber, polyphenylene ether-polystyrene, polyphenylene ether-polyamide or polyphenylene ether-polyester. Copolymers and alloys of any of the foregoing types and species of polymers may also be employed as substrates. Although the substrate layer may incorporate other thermoplastic polymers, the above-described condensation and/or addition polymers still more preferably constitute the major proportion thereof.

Preferred substrates of the present invention include fiber-reinforced polypropylene substrate or fiber-reinforced polyetherimide substrate. The fiber-reinforced polymer material of the substrate comprises a sufficient amount of polymer material and fibers to provide the desired structural integrity and void volume to the substrate. For example, the fiber-reinforced polymer substrate can include polymer material in a range between about 25 weight percent (wt %) and about 85 wt %, specifically in a range between about 35 wt % and about 65 wt %, and more specifically in a range between about 40 wt % and about 60 wt %. Fibers with the polymer material may be present in a range between about 15 wt % and about 75 wt %, specifically in a range between about 35 wt % and about 65 wt % and more specifically in a range between about 40 wt % and about 60 wt %. The weight percents are based on the total weight of the fiber-reinforced polymer substrate. Preferred reinforced polypropylene and reinforced polyetherimide are Azdel brand glass fiber-reinforced polypropylene and Azdel brand glass fiber-reinforced polyetherimide (Azdel, Inc.). The substrate used in making the composite multilayer article ranges in thickness from between about 1 mm and 10 mm and preferably is in a range between about 1.75 mm and about 6 mm.

In one embodiment of the present invention, the substrate layer also incorporates at least one filler and/or pigment. Illustrative extending and reinforcing fillers and pigments include silicates, zeolites, titanium dioxide, stone powder, glass fibers or spheres, carbon fibers, carbon black, graphite, calcium carbonate, talc, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers, carbon fibers, and metal fibers, as well as colorants such as metal flakes, glass flakes and beads, ceramic particles, other polymer particles, dyes and pigments which may be organic, inorganic or organometallic. In another embodiment the present invention encompasses multilayer articles comprising a filled thermoset substrate layer such as a sheet-molding compound (SMC) or bulk molding compound (BMC).

The substrate layer may also comprise at least one cellulosic material including, but not limited to, wood, paper, cardboard, fiber board, particle board, plywood, construction paper, Kraft paper, cellulose nitrate, cellulose acetate butyrate, and like cellulosic-containing materials. The present invention also encompasses blends of at least one cellulosic material and either at least one thermoset polymer (particularly an adhesive thermoset polymer), or at least one thermoplastic polymer (particularly a recycled thermoplastic polymer, such as PET or polycarbonate), or a mixture of at least one thermoset polymer and at least one thermoplastic polymer.

The substrate may be produced according to the Wiggins Teape method (e.g., as discussed in U.S. Pat. Nos. 3,938,782; 3,947,315; 4,166,090; 4,257,754; and 5,215,627). For example, to produce a mat according to the Wiggins Teape or similar method, fibers, thermoplastic material(s), and any additives are metered and dispersed into a mixing tank fitted with an impeller to form a mixture. The mixture is pumped to a head-box via a distribution manifold. The head box is located above a wire section of a machine of the type utilized for papermaking. The dispersed mixture passes through a moving wire screen using a vacuum, producing a uniform, fibrous wet web. The wet web is passed through a dryer to reduce moisture content and to melt the thermoplastic material(s). A non-woven scrim layer may also be attached to one side or to both sides of the web to facilitate ease of handling the substrate (e.g., to provide structural integrity to a substrate with a thermoset material). The substrate can then be passed through tension rolls and cut (e.g., guillotined) into the desired size.

The thermoplastic polymer of the top layer comprises structural units derived from at least one 1,3-dihydroxybenzene and at least one organodicarboxylic acid. Suitable polymers for this purpose, specifically arylate-comprising polymers, are disclosed, for example, in commonly owned U.S. Pat. No. 5,916,997, the disclosure of which is incorporated by reference herein. Arylate-comprising polymers having a glass transition temperature of at least about 80° C. and no crystalline melting temperature, i.e., those that are amorphous, are preferred.

In one embodiment of the present invention, the top layer polymer comprises a polyarylate with structural units derived from a 1,3-dihydroxybenzene and either isophthalic acid or terephthalic acid or a mixture thereof comprising structural units of formula I 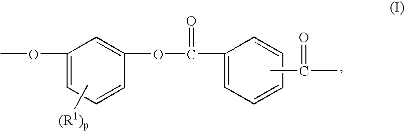
wherein each R¹ is a substituent, especially halo or C₁₋₁₂ alkyl, and p is 0-3, optionally in combination with structural units of formula II 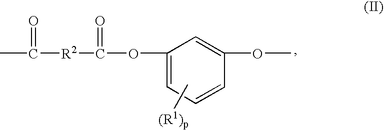
wherein R¹ and p are as previously defined and R² is a divalent C₃₋₂₂ aliphatic, alicyclic or mixed aliphatic-alicyclic radical. Moieties represented by R² are 1028980748often referred to as “soft block” units.

It is within the scope of the invention for other acid groups, such as those derived from aliphatic dicarboxylic acids such as succinic acid, adipic acid or cyclohexane-1,4-dicarboxylic acid, or from other aromatic dicarboxylic acids such as 2,6-naphthalenedicarboxylic acid, to be present, preferably in amounts no greater than about 30 mole percent. Most typically, however, the top layer may consist of units of formula I, optionally in combination with units of formula II.

The units of formula I contain a resorcinol or substituted resorcinol moiety in which any R¹ groups are preferably C₁₋₄ alkyl; i.e., methyl, ethyl, propyl or butyl. They are preferably primary or secondary groups, with methyl being more preferred. The most preferred moieties are resorcinol moieties, in which p is zero, although moieties in which p is 1 are also excellent with respect to the invention.

Said 1,3-dihydroxybenzene moieties are bound to one or more types of organodicarboxylic acid moieties, typically aromatic organodicarboxylic acid moieties which may be monocyclic, e.g., isophthalate or terephthalate, or polycyclic, e.g., naphthalenedicarboxylate. Preferably, the aromatic dicarboxylic acid moieties are isophthalate or terephthalate or a mixture thereof. Either or both of said moieties may be present. For the most part, both are present in a molar ratio of isophthalate to terephthalate in the range of between about 0.25:1 and about 4.0:1, preferably in the range of between about 0.4:1 and about 2.5:1, more preferably in the range of between about 0.67:1 and about 1.5:1, and most preferably in the range of between about 0.9:1 and about 1.1:1.

In the optional soft block units of formula II, resorcinol or substituted resorcinol moieties are again present in ester-forming combination with R² which is a divalent C₃₋₂₂ aliphatic, alicyclic or mixed aliphatic-alicyclic radical. Preferably, R² is a C₃₋₂₂ straight chain alkylene, C₃₋₁₂ branched alkylene, or C₄₋₁₂ cyclo- or bicycloalkylene group. More preferably, R² is aliphatic and especially C₈₋₁₂ straight chain aliphatic.

It is usually found that the arylate-comprising polymers most easily prepared, especially by interfacial methods, consist of units of formula I and especially structural units derived from resorcinol in combination with structural units derived from isophthalic acid and terephthalic acid units (sometimes referred to herein as resorcinol isophthalate/terephthalate) in a molar ratio in the range of between about 0.25:1 and about 4.0:1, preferably in the range of between about 0.4:1 and about 2.5:1, more preferably in the range of between about 0.67:1 and about 1.5:1, and most preferably in the range of between about 0.9:1 and about 1.1:1. When that is the case, the presence of soft block units of formula II is usually unnecessary. If the ratio of units of formula I is outside this range, and especially when they are exclusively iso- or terephthalate, the presence of soft block units may be preferred to facilitate interfacial preparation. A particularly preferred arylate-comprising polymer containing soft block units is one consisting essentially of resorcinol isophthalate and resorcinol sebacate units in a molar ratio in the range of between about 8.5:1.5 and about 9.5:0.5.

Arylate-comprising polymers useful as polymers for the top layer may be prepared by conventional esterification reactions which may be conducted interfacially, in solution, in the melt or under solid state conditions, all of which are known in the art. Typical interfacial preparation conditions are described for example in commonly owned U.S. Pat. No. 5,916,997, the disclosure of which is incorporated by reference herein.

Also useful as polymers for the top layer are the block copolyestercarbonates disclosed and claimed in copending, commonly owned application Ser. No. 09/368,706 and Ser. No. 09/416,529, the disclosures of which are also incorporated by reference herein. They include block copolymers comprising polyarylate structural units derived from a 1,3-dihydroxybenzene and either isophthalic acid or terephthalic acid or a mixture thereof in combination with carbonate structural units and having the formula 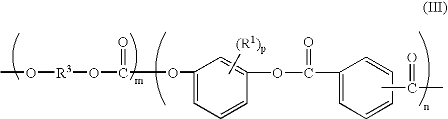
wherein R¹ and p are as previously defined, each R³ is independently a divalent organic radical, m is at least 1 and n is at least about 4. Preferably n is at least about 10, more preferably at least about 20 and most preferably about 30-150. Preferably m is at least about 3, more preferably at least about 10 and most preferably about 20-200. In especially preferred embodiments of the present invention, m is between about 20 and 50.

The arylate blocks contain structural units comprising 1,3-dihydroxybenzene moieties which may be unsubstituted or substituted. Alkyl substituents, if present, are preferably straight-chain or branched alkyl groups, and are most often located in the ortho position to both oxygen atoms although other ring locations are contemplated. Suitable C₁₋₁₂ alkyl groups include methyl, ethyl, n-propyl, isopropyl, butyl, iso-butyl, t-butyl, nonyl, decyl, and aryl-substituted alkyl, including benzyl, with methyl being particularly preferred. Suitable halogen substituents are bromo, chloro, and fluoro. 1,3-Dihydroxybenzene moieties containing a mixture of alkyl and halogen substituents are also suitable. The value for p may be 0-3, preferably 0-2, and more preferably 0-1. A preferred 1,3-dihydroxybenzene moiety is 2-methylresorcinol. The most preferred 1,3-dihydroxybenzene moiety is unsubstituted resorcinol in which p is zero. Polymers containing mixtures of 1,3-dihydroxybenzene moieties, such as a mixture of unsubstituted resorcinol with 2-methylresorcinol are also contemplated.

In the arylate structural units said 1,3-dihydroxybenzene moieties are bound to aromatic dicarboxylic acid moieties which may be monocyclic moieties, such as isophthalate or terephthalate or their chlorine-substituted derivatives; or polycyclic moieties, such as biphenyl dicarboxylate, diphenylether dicarboxylate, diphenylsulfone dicarboxylate, diphenylketone dicarboxylate, diphenylsulfide dicarboxylate, or naphthalenedicarboxylate, preferably naphthalene-2,6-dicarboxylate; or mixtures of monocyclic and/or polycyclic aromatic dicarboxylates. Preferably, the aromatic dicarboxylic acid moieties are isophthalate and/or terephthalate. Either or both of said moieties may be present. For the most part, both are present in a molar ratio of isophthalate to terephthalate in the range of between about 0.25:1 and about 4.0:1. When the isophthalate to terephthalate ratio is greater than about 4.0:1, then unacceptable levels of cyclic oligomer may form. When the isophthalate to terephthalate ratio is less than about 0.25:1, then unacceptable levels of insoluble polymer may form. Preferably the molar ratio of isophthalate to terephthalate is in a range of between about 0.4:1 and about 2.5:1, and more preferably in a range between about 0.67:1 and about 1.5:1, m is at least about 10 and n is at least about 4. Soft block moieties corresponding to formula II may also be present.

In the organic carbonate blocks, each R³ is independently a divalent organic radical. Preferably, said radical comprises at least one dihydroxy-substituted aromatic hydrocarbon, and at least about 60 percent of the total number of R³ groups in the polymer are aromatic organic radicals and the balance thereof are aliphatic, alicyclic, or aromatic radicals. Suitable R³ radicals include m-phenylene, p-phenylene, 4,4′-biphenylene, 4,4′-bi(3,5-dimethyl)-phenylene, 2,2-bis(4-phenylene)propane, 6,6′-(3,3,3′,3′-tetramethyl-1,1′-spirobi[1H-indan]) and similar radicals such as those which correspond to the dihydroxy-substituted aromatic hydrocarbons disclosed by name or formula (generic or specific) in U.S. Pat. No. 4,217,438, which is incorporated herein by reference. A particularly preferred divalent organic radical is 2,2-bis(p-phenylene)isopropylidene and the dihydroxy-substituted aromatic hydrocarbon corresponding thereto is commonly known as bisphenol A.

It is believed that the arylate-comprising polymers of the top layer undergo thermally or photochemically induced Fries rearrangement of arylate blocks to yield o-hydroxybenzophenone moieties or analogs thereof which serve as stabilizers to UV radiation. More particularly, at least a portion of arylate chain members can rearrange to yield chain members with at least one hydroxy group ortho to at least one ketone group. Such rearranged chain members are typically o-hydroxybenzophenone-type chain members and typically comprise one or more of the following structural moieties of formula IV, V, or VI: 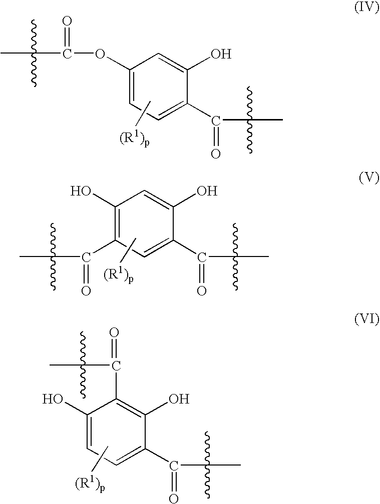
wherein R¹ and p are as previously defined. Thus, in one of its embodiments the top layer of the present invention comprise arylate-comprising polymers, at least a portion of which structural units have undergone Fries rearrangement. Fries rearrangement typically gives polymer with structural units represented by a combination of Formulas VII and VIII, 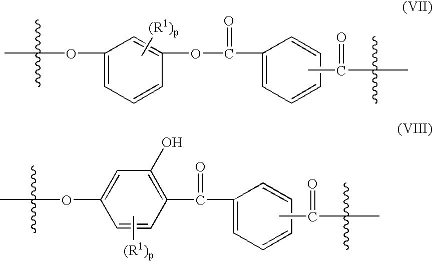
wherein R¹ and p are as previously defined and wherein the molar ratio of structural units represented by Formula VII to structural units represented by Formula VIII is in a range between about 99:1 and about 1:1, and preferably in a range between about 99:1 and about 80:20. Although iso- and terephthalate units are illustrated in Formulas VII and VIII, the dicarboxylic acid residues in the arylate residues may be derived from any suitable dicarboxylic acid residue, as defined hereinabove, or mixture of suitable dicarboxylic acid residues. In preferred embodiments of the present invention, p in both Formulas VII and VIII is zero and the arylate blocks comprise dicarboxylic acid residues derived from a mixture of iso- and terephthalic acid residues. It is also contemplated to introduce moieties of the types illustrated in Formulas IV, V, and VI via synthesis and polymerization of appropriate monomers in arylate-comprising polymers.

In a further embodiment, the top layer comprises compositions containing copolyestercarbonates containing structural units comprising those shown in Formula IX: 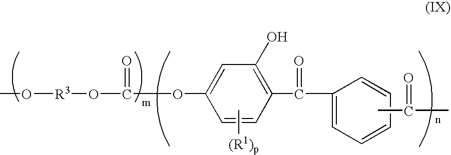
wherein R¹, R³, p, m, and n are as previously defined.

Within the context of the present invention it should be understood that the top layer comprising resorcinol arylate polyester chain members will also include polymer comprising o-hydroxy-benzophenone or analogous chain members resulting from Fries rearrangement of said resorcinol arylate chain members, for example after exposure of said coating layer to UV-light. Typically, a preponderance of polymer comprising o-hydroxy-benzophenone or analogous chain members will be on that side or sides of said coating layer exposed to UV-light and will overlay in a contiguous superposed layer or layers the polymer comprising unrearranged resorcinol arylate chain members. If it is worn away or otherwise removed, polymer comprising o-hydroxybenzophenone or analogous chain members is capable of regenerating or renewing itself from the resorcinol arylate-containing layer or layers, thus providing continuous protection for any UV-light sensitive layers.

It is also within the scope of the invention for other polymers to be present which are miscible in at least some proportions with the polymer top layer comprising polymer comprising structural units derived from at least one 1,3-dihydroxybenzene and at least one organodicarboxylic acid. Illustrative examples of at least partially miscible polymers include polyetherimide and polyesters such as poly(1,4-butylene terephthalate) (PBT), poly(ethylene terephthalate) (PET), poly(trimethylene terephthalate) (PTT), poly(ethylene naphthalate) (PEN), poly(butylene naphthalate) (PBN), poly(cyclohexanedimethanol-co-ethylene terephthalate) (PETG), poly(1,4-cyclohexanedimethyl-1,4-cyclohexanedicarboxylate) (PCCD), and bisphenol A polyarylate. Preferably, a top layer polymer consists essentially of the polymer including structural units derived from at least one 1,3-dihydroxybenzene and at least one organodicarboxylic acid.

The formation of the compositions of the invention may be effected by art-recognized blending techniques. These include melt blending and solution blending.

In another embodiment the multilayer article of the present invention comprises an interlayer, for example an adhesive interlayer (sometimes known as a tielayer), between any substrate layer and any top layer. Within the present context a multilayer article is one which contains two or more layers. Multilayer articles of the invention include, but are not limited to, those which comprise a substrate layer and a top layer; those which comprise a substrate layer with a top layer on each side of said substrate layer; and those which comprise a substrate layer and at least one top layer with at least one interlayer between the substrate layer and a top layer. Any interlayer may be transparent, translucent, or opaque, and/or may contain an additive, for example a colorant or decorative material such as metal flake. If desired, an overlayer may be included over the top layer of the invention, for example to provide abrasion or scratch resistance. The substrate layer, top layer of the invention, and any interlayers or overcoating layers are preferably in contiguous superposed contact with one another.

The multilayer articles typically have outstanding initial gloss, improved initial color, weatherability, impact strength, and resistance to organic solvents encountered in their final applications. Generally, the surface of the multilayer article has an aesthetically pleasing exterior surface. The automotive industry describes the desired exterior surface as an exterior class-A surface finish. Said articles may also be recyclable by reason of the compatibility of the discrete layers therein.

Multilayer articles encompassed by the present invention also include those comprising a supplemental thermoplastic layer. The supplemental thermoplastic layer may be any addition or condensation thermoplastic polymer described above. For example, the supplemental may comprise resorcinol arylate polyester chain members as found in the top layer.

Multilayer articles encompassed by the invention also include those comprising at least one glass layer as a supplemental layer. The glass layer may be contiguous to the top layer, contiguous to the substrate layer, or interposed between a top layer and a substrate layer. Depending upon the nature of the glass layer and the layer to which it is contiguous, at least one adhesive interlayer may be beneficially employed between any glass layer and any top layer or substrate layer of the invention. The adhesive interlayer may be transparent, opaque or translucent. For many applications it is preferred that the interlayer be optically transparent in nature and generally have a transmission of greater than about 60% and a haze value less than about 3% with no objectionable color.

Another aspect of the invention is a method for preparing a multilayer article which comprises applying at least one top layer of the composition of the invention to the substrate layer.

Formation of the multilayer article may be performed by a variety of means. More preferably, application of said top layer comprises fabrication of a separate sheet thereof followed by application to the substrate layer. Thus, there may be employed such methods as thermoforming (e.g. vacuum molding), compression molding, overmolding, blow molding, multi-shot injection molding and placement of a film of a top layer material on the surface of a substrate layer followed by adhesion of the two layers, typically in an injection molding apparatus; e.g., in-mold decoration, or in a hot-press. These operations may be conducted under art-recognized conditions.

In one method of preparing the multilayer article the substrate is thermoformed or compression molded into the substrate layer of the final part and cooled. A thermoformed and trimmed top layer with an adhesive interlayer on one side is placed on top of the pre-formed and cooled substrate layer such that the adhesive interlayer is an interlayer between the top layer and the substrate layer. The stack is then placed on a heated mold under heat at a temperature below the glass transition temperature of the top layer polymer and under low to moderate pressure to form the final multilayer article. Typically, the temperature is in a range between about 20° C. and about 150° C., and more typically in a range between about 35° C. and about 125° C. Typically, the pressure is in a range between about 15 psi and about 800 psi, and more typically in a range between about 100 psi and about 500 psi.

In yet another embodiment of the present invention, the substrate layer is thermoformed or compression molded into the substrate layer of the final part and cooled as described above. Thereafter, a uniform layer of adhesive interlayer is applied to the surface of the pre-formed and cooled substrate layer and a thermoformed and trimmed top layer is then placed on top of the adhesive interlayer. The whole stack is then placed on a heated mold under heat and pressure to form the final multilayer article. Also, a conforming silicone or rubber padding may be used in the mold to retain class-A surface finish of the top layer.

In yet another embodiment of the present invention, the top layer is sheeted and thermoformed to a “skin” of the final part. This skin is then trimmed such that it matches the shape of the final part. The skin is then placed into the cavity of the compression tool with the aesthetic side of the film against the tool surface and with the mold temperature set below the glass transition temperature of the top layer polymer. The substrate layer is then heated in an external oven or press to a temperature in a range between about 180° C. and about 370° C. (depending on the nature of the substrate) and the hot substrate layer is immediately transferred to the compression tool to minimize air-cooling of the substrate layer. Placing the top layer and the substrate layer in the tool in this manner enables the top layer to be separated from the hot substrate layer until the tool is nearly closed which minimizes glass read-through and other surface imperfections. The tool is then closed at which time the top layer comes into contact with the pre-heater substrate at a pressure in a range between about 10 psi and about 900 psi. The substrate layer fills the cavity, bonds with the top layer, and cools. The tool opens and the multilayer aesthetic part can be removed. An adhesive interlayer may or may not be present.

In yet another embodiment of the present invention, the multilayer article is prepared by IMD/injection molding process of the top layer and the substrate layer. The thermoformed and trimmed top layer is placed into the cavity of an injection-molding toll, with the aesthetic side of the top layer against the tool surface and with the mold temperature set below the glass transition temperature of the top layer polymer. Molded substrate layer is also placed in the cavity of the injection-molding tool. A thermoplastic resin is then injection molded into the cavity as an adhesive interlayer. During the injection molding process, the molten thermoplastic resin effectively flows between the top layer and the substrate layer and ties the top layer and the substrate layer together.

The thicknesses of the various layers in multilayer articles of this invention are most often as follows:
substrate layer—in a range between about 1 mm and about 10 mm, preferably in a range between about 1.75 mm and about 6.0 mm,
top layer—in a range between about 2 μm and about 2,500 μm, preferably in a range of between about 10 μm and about 250 μm and most preferably in a range between about 50 μm and about 175 μm,
second material, if any—in a range between about 2 μm and about 2,500 μm, preferably in a range between about 10 μm and about 250 μm, and most preferably in a range between about 50 μm and about 175 μm,
total—at least about 125 μm, preferably at least about 250 μm, more preferably at least about 400 μm.

The multilayer articles of this invention are characterized by the usual beneficial properties of the substrate layer and top layer, in addition to weatherability as evidenced by improved resistance to ultraviolet radiation and maintenance of gloss, and solvent resistance. Depending upon the top layer/substrate layer combination, the multilayer articles may possess recycling capability, which makes it possible to employ the regrind material as a substrate for further production of articles of the invention.

Representative multilayer articles which can be made which comprise the composition of the invention include aircraft, automotive, truck, military vehicle (including automotive, aircraft, and water-borne vehicles), and motorcycle exterior and interior components, including panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. The invention further contemplates additional fabrication operations on said articles, such as, but not limited to, molding, in-mold decoration, baking in a paint oven, lamination, and/or thermoforming.

In order that those skilled in the art will be better able to practice the present disclosure, the following examples are given by way of illustration and not by way of limitation.

Commercial and experimental grades of 2000 grams per square meter (GSM) Xenoy®, Lexan®, and Ultem® SuperLite sheet, and Polypropylene SuperLite (1600 GSM) were obtained from Azdel, Inc. A 15-mil thick thermoplastic polyurethane film (grade A4700) was obtained from Deerfield Urethanes, Inc. A 2-mil thick Vitel 1912 co-polyester film was obtained from Bostik Findley, Inc. Araldite 2040 2-component urethane adhesive was obtained from Ventico Inc. Hybrar 7125 resin was obtained from Kuraray Co. It was injection molded into 1/16″ plaque and then compression molded into 10-mil thick film. Both A4700 and Hybrar films were laminated to the back of Lexan® SLX films (obtained from General Electric) at 125° C. and 50 psi for 1 minute.

Surface quality characterization was conducted by using a BYK Gardner Wavescan instrument. Wavescan measures reflection of light images in the <1 mm to 30 mm length. Lower values on the Wavescan plot correspond to better surfaces.

### EXAMPLES 1-4

### Secondary Operation Process (2-hit Process) for making Lexan® SLX film/SuperLite Articles

10″×10″ Ultem®, Xenoy®, Lexan® and Polypropylene SuperLite sheets were molded at the molding conditions listed in Table 2. First, the SuperLite sheets was preheated under minimal pressure for 2 minutes, then pressed at high pressure for 2 minutes and the molded sheet and plates were transferred to the cooling press for a couple of minutes under minimal pressure, just enough to counteract the tendency to loft. The degree of lofting could be controlled by putting the appropriate stop blocks between the plates. These conditions listed in Table 1 allowed for getting good wet-out prior to lofting for optimal mechanical properties. To make fully consolidated samples, no stop blocks were needed. In examples 1-4, stop blocks were used to set the gap and the final thickness of the molded sheet to 1/10″.

TABLE 2
SuperLite processing conditions

| | | Molding | |
|---|---|---|---|
| Example | SuperLite | Temperature (° C.) | Molding Pressure (psi) |
| 1 | Ultem ® | 330 | 800 |
| 2 | Lexan ® | 275 | 450 |
| 3 | Xenoy ® | 260 | 150 |
| 4 | Polypropylene | 190 | 15 |

In Examples 1-3, a Lexan® SLX film with a 15 mil thick A4700 thermoplastic polyurethane interlayer laminated on the back was used. In Example 4, a Lexan® SLX film with a 10 mil Hybrar 7125 film adhesive interlayer laminated on the back was used. The Lexan® SLX film with adhesive interlayer on the backside was then put on top of the molded and cooled Ultem®, Lexan®, Xenoy®, or Polypropylene SuperLite substrate, respectively. The whole assembly was then placed in a heated mold under 130° C. and 150 psi pressure for 4 minutes.

A 90° peel test was used for evaluating film/substrate adhesion for the multilayer system. The 90° peel testing apparatus consists of an Instron fitted with a jig consisting of a series of movable rollers which allow the test specimen to be peeled at a constant 90° angle along its entire peel length. The ends or “tabs” of the specimen were placed in the jaws of an Instron and then separated at a chosen peel rate of 1 inch/minute. The “tabs” were formed by inserting a polyimide (Kapton™) tape between Lexan® SLX film or sheet and the adhesive interlayer before molding. The average 90° peel strength for Xenoy®, Ultem®, Lexan®, and Polypropylene SuperLite substrates was found to be 12.2, 12.5, 13.8, and 10.5 pounds force per linear inch. In all cases, the peel failure modes were found to be SuperLite substrate cohesive failure. In other words, the adhesive strength exceeded the cohesive strength of molded SuperLite. In all cases, the surface of the molded multilayer articles retained excellent surface quality of the co-extruded Lexan® SLX film.

### Examples 5-7

### Secondary Operation Process (2-hit process) for making Lexan® SLX film/SuperLite Articles

10″×10″ Ultem®, Xenoy®, and Lexan® SuperLite sheets were molded at the same molding conditions as examples 1-3. A uniform layer of 4 mil thick Araldite 2040 2-component reactive urethane adhesive interlayer was then applied to the surface of the pre-formed SuperLite substrate. A Lexan® SLX film was then placed on top of the adhesive interlayer. The whole stack of Lexan® SLX film/Adhesive/Ultem SuperLite was then placed on a heated molded under 100° C. and 50 psi pressure for 3 minutes to form the final multilayer article. The average 90° peel strength for Lexan® SLX film over Xenoy®, Ultem®, and Lexan® SuperLite substrates was found to be 15, 14.1, and 17 pounds per linear inch with a combination of adhesive interlayer cohesive and interfacial peel failures. The penetration of Araldite 2040 to the porous SuperLite substrates was contributed to higher cohesive strength of the substrates, and hence high peel strength.

### Example 8

### IMD/Compression Molding for Making Lexan® SLX film/SuperLite Articles (without Adhesive Interlayer)

A flat 10″×10″ Lexan® SLX film was placed into the cavity of a warmed compression tool with the aesthetic side of the film against the tool surface and with the mold temperature set at 130° C. Xenoy® SuperLite sheet was heated in a separate heated press to 270° C. under minimum pressure for 4 minutes and was then immediately transferred to the compression tool. The tool was closed at which time the Lexan® SLX film came into contact with the hot SuperLite sheet under a molding pressure of 300 psi. The SuperLite sheet was molded into the final shape and bonded with Lexan® SLX film inside the tool for 2 minutes. The tool opened and the aesthetic part was removed. The 90° peel strength was found to be 14.3 pounds and the peel failure mode was cohesive Xenoy® SuperLite substrate.

### Example 9-12

### IMD/Compression Molding for Making Lexan® SLX Film/Superlite (with Adhesive Interlayer)

In Examples 9-11, a 30 mil Lexan® SLX film with a 15-mil A4700 TPU adhesive interlayer laminated on the backside was used. In Example 12, a Lexan® SLX film with a 10 mil Hybrar 7125 film adhesive interlayer laminated on the backside was used. The 10″×10″ Lexan® SLX film with adhesive interlayer laminated on the back was placed into the cavity of a warmed compression tool with the mold temperature set at 120° C.-130° C. and with the aesthetic side of the film against the tool surface. Xenoy®, Lexan®, Ultem®, or Polypropylene SuperLite sheet was heated in a separated heated press to 270° C., 270° C., 330° C., and 210° C. respectively under minimum pressure for 4 minutes, and was then immediately transferred to the compression tool set at a temperature of 120° C.-130° C. The tool was then closed at which time the Lexan® SLX film (with adhesive interlayer laminated on the back) came into contact with the hot SuperLite sheet under a molding pressure listed in Table 3. The SuperLite sheet was molded into the final shape and then bonded with Lexan® SLX film inside the tool for 4 minutes. The tool opened and the aesthetic part was removed. Similar to Examples 1-4, the adhesion of the Lexan® SLX film to Polypropylene, Ultem®, Lexan®, and Xenoy® SuperLite substrates were found to be excellent. The adhesion strength was found to exceed the cohesive strength of the molded SuperLite substrate in all cases. Results can be seen in Table 2.

TABLE 2

| | | Heater | Molding Press | |
|---|---|---|---|---|
| | | Press Set | Set | Molding |
| | | Temperature T₁ | Temperature | Pressure |
| Example | SuperLite Type | (° C.) | T₂ (° C.) | (psi) |
| 9 | Xenoy ® | 270 | 130 | 300 |
| 10 | Lexan ® | 270 | 130 | 350 |
| 11 | Ultem ® | 330 | 130 | 800 |
| 12 | Polypropylene | 210 | 120 | 20 |

### Example 13-18

### IMD/Injection Molding for Making Lexan® SLX Film/Superlite

A 30 mil×3.5 inch×4 inch Lexan® SLX film was placed in the cavity of a 3/16 inch×4 inch×4 inch plaque mold with the aesthetic side of the film against the tool surface. A molded 3.5 inch×4 inch sheet of SuperLite was also placed in the mold cavity. Xenoy® 5220 or Lexan® 141 resin was injection molded between the Lexan® SLX film and the SuperLite sheet. A Nissei FE160 injection molder was used. The mold temperature was set at 145° F., injection pressure was set at 9000-12000 psi, injection speed was set at 1.1 inch per second, and the cycle time was set at 45 seconds. The temperature profile was set at 495° F. (zone 1, nozzle), 490° C. (zone 2, front), 485° C. (zone 3, middle), and 480 (zone 4, rear for injection molding of Xenoy® 5220), and 532° F. (zone 1, nozzle), 537° F. (zone 2, front), 540° F. (zone 3, middle) and 540° F. (zone 4, rear).

TABLE 3
SuperLite processing conditions

| Example | SuperLite Type | Molding Resin |
|---|---|---|
| 13 | Xenoy ® | Lexan ® 141 |
| 14 | Xenoy ® | Xenoy ® 5220 |
| 15 | Lexan ® | Lexan ® 141 |
| 16 | Lexan ® | Xenoy ® 5220 |
| 17 | Ultem ® | Lexan ® 141 |
| 18 | Ultem ® | Xenoy ® 5220 |

The adhesion of the Lexan® SLX film to Lexan®, Xenoy®, and Ultem® SuperLite substrates was found to be excellent. The adhesion strength was found to exceed the cohesive strength of the SuperLite substrate in all cases. The excellent adhesion was due to the compatibility between Lexan® and Xenoy® resins with the Lexan® SLX film and SuperLite substrates, and/or strong mechanical interlocking. Optical microscopy showed that at high injection molding temperature and pressure, the molted resin penetrated to the porous SuperLite substrates and solidified, resulting in strong mechanical interlocking and hence, contributing to strong adhesion.

### Example 19

### Surface Quality Characterization by Wave-Scan Method

A process as those described in Example 13-14 was used for making Lexan® SLX.film/Xenoy® SuperLite article. All processing conditions were the same as those in Example 13-14 except that 30 mil thick Estate Green Lexan® SLX film was used and the Xenoy® NBX218 resin was injection molded between the formed SuperLite and Lexan® SLX film. The surface quality of the Xenoy® SuperLite In-Mold decorated with Lexan® SLX is of “Class-A” surface that is better than that of painted automotive exteriors. Results can be seen in FIG. 1.

Although preferred and other embodiments of the disclosure have been described herein, further embodiments may be perceived by those skilled in the art without departing from the scope of the disclosure as defined by the following claims.

1. A multilayer article comprising:
a substrate layer comprising at least one thermoplastic polymer and fiber in a range between about 15 weight % and about 75 weight % based on the total weight of the fiber-reinforced polymer substrate, and
at least one top layer comprising at least one thermoplastic polymer comprising structural units derived from at least one 1,3-dihydroxybenzene and at least one organodicarboxylic acid.

2. The multilayer article according to claim 1, wherein the substrate layer includes a polymer selected from the group consisting of polycarbonates, polyesters, polyetherimides, blends, copolymers, and alloys thereof.

3. The multilayer article according to claim 1, wherein the substrate layer includes a polymer selected from the group consisting of polypropylenes, polyphenylene ethers, polystyrenes, polyamides, blends, copolymers, and alloys thereof.

4. The multilayer article according to claim 1, wherein the fiber comprises glass fiber.

5. The multilayer article according to claim 1, wherein the fiber comprises dispersed chopped glass fiber.

6. The multilayer article according to claim 1, wherein the fiber is present in a range between about 40 weight % and about 60 weight % based on the total weight of the fiber-reinforced polymer substrate.

7. The multilayer article according to claim 1, wherein the top layer comprises a block copolyestercarbonate.

8. The multilayer article according to claim 7, wherein the at least one 1,3-dihydroxybenzene is unsubstituted resorcinol.

9. The multilayer article according to claim 7, wherein the at least one organodicarboxylic acid is a mixture of isophthalic acid and terephthalic acid.

10. The multilayer article according to claim 9, wherein the ratio of isophthalic-derived structural units to terephthalic-derived structural units is about 0.25-4.0:1.

11. The multilayer article according to claim 10, wherein the ratio of isophthalic-derived structural units to terephthalic-derived structural units is about 0.40-2.5:1.

12. The multilayer article according to claim 1, further comprising at least one supplemental thermoplastic layer.

13. The multilayer article according to claim 12, wherein the supplemental thermoplastic layer comprises structural units derived from at least one 1,3-dihydroxybenzene and at least one organodicarboxylic acid.

14. The multilayer article according to claim 12, wherein the supplemental thermoplastic layer is in contiguous contact with the substrate layer and the top layer is in contiguous contact with the substrate layer.

15. The multilayer article according to claim 1, further comprising at least one adhesive tielayer.

16. The multilayer article according to claim 1, wherein the substrate layer has a stiffness to weight ratio in a range between about 100,000 psi and about 1,000,000 psi

17. The multilayer article of claim 1 which is an aircraft, automotive, truck, military vehicle, military aircraft, water-borne military vehicle, or motorcycle exterior or interior component, a panel, quarter panel, rocker panel, trim, fender, door, decklid, trunklid, hood, bonnet, roof, bumper, fascia, grill, mirror housing, pillar applique, cladding, body side molding, wheel cover, hubcap, door handle, spoiler, window frame, headlamp bezel, headlamp, tail lamp, tail lamp housing, tail lamp bezel, license plate enclosure, roof rack, or running board; an enclosure, housing, panel, or part for an outdoor vehicle or outdoor device; an enclosure for an electrical or telecommunication device; outdoor furniture; an article for boat or marine equipment, trim, enclosures, and housings; an outboard motor housing; a depth finder housing; a personal water-craft; a jet-ski; a pool; a spa; a hot-tub; a step; a step covering; a building or construction application glazing, roofs, windows, floors, decorative window furnishings or treatments; a treated glass cover for pictures, painting, posters, or display items; an optical lens; an ophthalmic lens; a corrective ophthalmic lens; an implantable ophthalmic lens; a wall panel, or door; a protected graphic; an outdoor or indoor sign; an enclosure, housing, panel, or part for automatic teller machines (ATM); an enclosure, housing, panel, or part for lawn or garden tractors, lawn mowers, or tools, lawn and garden tools; a window or door trim; an article of sports equipment or a toy; an enclosure, housing, panel, or part for a snowmobile; a recreational vehicle panel or component; an article of playground equipment; an article made from combinations of plastic and wood; a golf course marker; a utility pit cover; a computer housing; a desk-top computer housing; a portable computer housing; a lap-top computer housing; a palm-held computer housing; a monitor housing; a printer housing; a keyboard; a FAX machine housing; a copier housing; a telephone housing; a mobile phone housing; a radio sender housing; a radio receiver housing; a light fixture; a lighting appliance; a network interface device housing; a transformer housing; an air conditioner housing; an article of cladding or seating for public transportation; an article of cladding or seating for trains, subways, or buses; a meter housing; an antenna housing; an article of cladding for satellite dishes; a coated helmet or other article of personal protective equipment; a coated synthetic or natural textile; a coated photographic film or photographic print; a coated painted article; a coated dyed article; a coated fluorescent article; or a coated foam article.

18. A multilayer article comprising:
a substrate layer comprising at least one polypropylene polymer and glass fiber in a range between about 15 weight % and about 75 weight % based on the total weight of the fiber-reinforced polypropylene substrate,
at least one top layer comprising at least one thermoplastic polymer comprising structural units derived from unsubstituted resorcinol and a mixture of isophthalic acid and terephthalic acid, and
at least one adhesive interlayer between the substrate layer and the top layer.

19. A multilayer article comprising:
a substrate layer comprising at least one polyetherimide polymer and glass fiber in a range between about 15 weight % and about 75 weight % based on the total weight of the fiber-reinforced polyetherimide substrate, and
at least one top layer comprising at least one thermoplastic polymer comprising structural units derived from unsubstituted resorcinol and a mixture of isophthalic acid and terephthalic acid.

20. A process for making a multilayer article comprising
forming a substrate layer comprising at least one thermoplastic polymer and fiber in a range between about 15 weight % and about 75 weight % based on the total weight of the fiber-reinforced polymer substrate,
cooling the substrate layer,
placing a top layer comprising at least one thermoplastic polymer comprising structural units derived from at least one 1,3-dihydroxybenzene and at least one organodicarboxylic acid on the cooled substrate layer, and
molding the multilayer article by heating the substrate layer and top layer at a temperature less than the glass transition temperature of the thermoplastic polymer top layer and at a pressure in a range between about 15 psi and about 800 psi.

21. The process according to claim 20, further comprising placing an adhesive interlayer between the substrate layer and the top layer.

22. The process according to claim 21, wherein the step of placing an adhesive interlayer comprises placing the adhesive interlayer on the surface of the top layer prior to placing the top layer on the substrate layer.

23. The process according to claim 21, wherein the step of placing the adhesive interlayer comprises placing the adhesive interlayer on the surface of the substrate layer prior to placing the top layer on the substrate layer.

24. The process according to claim 20, wherein the step of forming the substrate layer comprises thermoforming the substrate layer.

25. The process according to claim 20, wherein the step of forming the substrate layer comprises compression molding the substrate layer.

26. The process according to claim 20, wherein the step of placing the top layer comprises a thermoformed top layer.

27. The process according to claim 20, wherein the step of forming the substrate layer comprises forming a substrate layer which includes a polymer selected from the group consisting of polycarbonates, polyesters, polyetherimides, blends, copolymers, and alloy thereof.

28. The process according to claim 20, wherein the step of forming the substrate layer comprises forming a substrate layer which includes a polymer selected from the group consisting of polypropylenes, polyphenylene ethers, polystyrenes, polyamides, blends, copolymers, and alloys thereof.

29. The process according to claim 20, wherein the step of forming the substrate layer comprising forming a substrate layer including dispersed chopped glass fibers.

30. The process according to claim 20, wherein the step of placing the top layer comprises a top layer wherein the at least one organodicarboxylic acid is a mixture of isophthalic acid and terephthalic acid.

31. The process according to claim 20, wherein the step of placing the top layer comprises a top layer wherein the 1,3-dihydroxybenzene is unsubstituted resorcinol.

32. A process for making a multilayer article comprising
forming a substrate layer comprising polypropylene polymer and dispersed chopped glass fiber in a range between about 15 weight % and about 75 weight % based on the total weight of the fiber-reinforced polypropylene substrate,
cooling the substrate layer,
placing a top layer comprising at least one thermoplastic polymer comprising structural units derived from unsubstituted resorcinol and a mixture of isophthalic acid and terephthalic acid on the cooled substrate layer, and
molding the multilayer article by heating the substrate layer and top layer at a temperature less than the glass transition temperature of the thermoplastic polymer top layer and at a pressure in a range between about 15 psi and about 800 psi.

33. A process for making a multilayer article comprising
forming a substrate layer comprising polyetherimide polymer and dispersed chopped glass fiber in a range between about 15 weight % and about 75 weight % based on the total weight of the fiber-reinforced polypropylene substrate,
cooling the substrate layer,
placing a top layer comprising at least one thermoplastic polymer comprising structural units derived from unsubstituted resorcinol and a mixture of isophthalic acid and terephthalic acid on the cooled substrate layer, and
molding the multilayer article by heating the substrate layer and top layer at a temperature less than the glass transition temperature of the thermoplastic polymer top layer and at a pressure in a range between about 15 psi and about 800 psi.

34. A process for making a multilayer article comprising:
forming a top layer comprising at least one thermoplastic polymer comprising structural units derived from at least one 1,3-dihydroxybenzene and at least one organodicarboxylic acid,
heating a substrate layer comprising at least one thermoplastic polymer and fiber in a range between about 15 weight % and about 75 weight % based on the total weight of the fiber-reinforced polymer substrate to a temperature in a range between about 180° C. and about 370° C.,
placing the top layer and the heated substrate layer in a compression mold wherein the aesthetic side of the top layer is contiguous to the surface of the compression mold, and
molding the top layer and heated substrate layer at a temperature below the glass transition temperature of the thermoplastic polymer top layer and at a pressure in a range between about 10 psi and about 900 psi.

35. The process according to claim 34, further comprising placing an adhesive interlayer between the substrate layer and the top layer.

36. The process according to claim 35, wherein the step of placing an adhesive interlayer comprises placing the adhesive interlayer on the surface of the top layer prior to placing the top layer in the compression mold.

37. The process according to claim 35, wherein the step of placing the adhesive interlayer comprises placing the adhesive interlayer on the surface of the substrate layer prior to placing the top layer on the substrate layer.

38. The process according to claim 34, wherein the step of forming a top layer comprises a thermoformed top layer.

39. The process according to claim 34, wherein the step of forming the substrate layer comprises forming a substrate layer which includes a polymer selected from the group consisting of polycarbonates, polyesters, polyetherimides, blends, copolymers, and alloys thereof.

40. The process according to claim 34, wherein the step of forming the substrate layer comprises forming a substrate layer which includes a polymer selected from the group consisting of polypropylenes, polyphenylene ethers, polystyrenes, polyamides, blends, copolymers, and alloys thereof.

41. The process according to claim 34, wherein the step of forming the substrate layer comprising forming a substrate layer including dispersed chopped glass fibers.

42. The process according to claim 34, wherein the step of forming the top layer comprises a top layer wherein the at least one organodicarboxylic acid is a mixture of isophthalic acid and terephthalic acid.

43. The process according to claim 34, wherein the step of forming the top layer comprises a top layer wherein the 1,3-dihydroxybenzene is unsubstituted resorcinol.

44. A process for making a multilayer article comprising:
thermoforming a top layer comprising structural units derived from unsubstituted resorcinol and a mixture of isophthalic acid and terephthalic acid,
heating a substrate layer comprising polypropylene polymer and dispersed chopped glass fibers in a range between about 15 weight % and about 75 weight % based on the total weight of the fiber-reinforced polypropylene substrate to a temperature in a range between about 180° C. and about 370° C.,
placing the top layer and the heated substrate layer in a compression mold wherein the aesthetic side of the top layer is contiguous to the surface of the compression mold, and
molding the top layer and heated substrate layer at a temperature below the glass transition temperature of the thermoplastic polymer top layer and at a pressure in a range between about 10 psi and about 900 psi.

45. A process for making a multilayer article comprising:
thermoforming a top layer comprising structural units derived from unsubstituted resorcinol and a mixture of isophthalic acid and terephthalic acid,
heating a substrate layer comprising polyetherimide polymer and dispersed chopped glass fibers in a range between about 15 weight % and about 75 weight % based on the total weight of the fiber-reinforced polypropylene substrate to a temperature in a range between about 180° C. and about 370° C.,
placing the top layer and the heated substrate layer in a compression mold wherein the aesthetic side of the top layer is contiguous to the surface of the compression mold, and
molding the top layer and heated substrate layer at a temperature below the glass transition temperature of the thermoplastic polymer top layer and at a pressure in a range between about 10 psi and about 900 psi.

46. A process for making a multilayer article comprising:
placing a top layer comprising at least one thermoplastic polymer comprising structural units derived from at least one 1,3-dihydroxybenzene and at least one organodicarboxylic acid in an injection molding tool wherein the aesthetic side of the top layer is contiguous to the surface of the tool,
placing a substrate layer comprising at least one thermoplastic polymer and fiber in a range between about 15 weight % and about 75 weight % based on the total weight of the fiber-reinforced polymer substrate in the injection molding tool,
injection molding a thermoplastic resin between the top layer and the substrate layer.

47. The process according to claim 46, wherein the step of placing the substrate layer comprises placing a substrate layer which includes a polymer selected from the group consisting of polycarbonates, polyesters, polyetherimides, blends, copolymers, and alloys thereof.

48. The process according to claim 46, wherein the step of placing the substrate layer comprises placing a substrate layer which includes a polymer selected from the group consisting of polypropylenes, polyphenylene ethers, polystyrenes, polyamides, blends, copolymers, and alloys thereof.

49. The process according to claim 46, wherein the step of placing the substrate layer comprises placing a substrate layer including dispersed chopped glass fibers.

50. The process according to claim 46, wherein the step of placing the top layer comprises a top layer wherein the at least one organodicarboxylic acid is a mixture of isophthalic acid and terephthalic acid.

51. The process according to claim 46, wherein the step of placing a top layer comprises a top layer wherein the 1,3-dihydroxybenzene is unsubstituted resorcinol.

52. A process for making a multilayer article comprising:
placing a top layer comprising at least one thermoplastic polymer comprising structural units derived from unsubstituted resorcinol and a mixture of isophthalic acid and terephthalic acid in an injection molding tool wherein the aesthetic side of the top layer is contiguous to the surface of the tool,
placing a substrate layer comprising polypropylene polymer and dispersed chopped glass fiber in a range between about 15 weight % and about 75 weight % based on the total weight of the fiber-reinforced polypropylene substrate in the injection molding tool,
injection molding a thermoplastic resin between the top layer and the substrate layer.

53. A process for making a multilayer article comprising:
placing a top layer comprising at least one thermoplastic polymer comprising structural units derived from unsubstituted resorcinol and a mixture of isophthalic acid and terephthalic acid in an injection molding tool wherein the aesthetic side of the top layer is contiguous to the surface of the tool,
placing a substrate layer comprising polyetherimide polymer and dispersed chopped glass fiber in a range between about 15 weight % and about 75 weight % based on the total weight of the fiber-reinforced polypropylene substrate in the injection molding tool,
injection molding a thermoplastic resin between the top layer and the substrate layer.
